(19) United States
(12) Patent Application Publication
(10) Pub. No.: US 2025/0142555 A1
(43) Pub. Date: May 1, 2025

(54) COORDINATED FREQUENCY DIVISION MULTIPLE ACCESS

(71) Applicant: Cisco Technology, Inc., San Jose, CA (US)

(72) Inventors: Malcolm M. Smith, Richardson, TX (US); Brian D. Hart, Sunnyvale, CA (US)

(73) Assignee: Cisco Technology, Inc., San Jose, CA (US)

(21) Appl. No.: 18/495,910

(22) Filed: Oct. 27, 2023

(51) Int. Cl. H04W 72/12; H04W 74/08

(52) U.S. Cl. CPC H04W 72/12; H04W 74/0808

(57) ABSTRACT

Coordinated Frequency Division Multiple Access (C-FDMA) may be provided. C-FDMA may include determining sub-channels of a channel for each of a plurality of Access Points (APs). The sub-channels may then be assigned to the plurality of APs. Transmit Opportunities (TxOps) may be scheduled for the plurality of APs on the sub-channels.

### TECHNICAL FIELD

The present disclosure relates generally to Coordinated Frequency Division Multiple Access (C-FDMA).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Coordinated Frequency Division Multiple Access (C-FDMA);

FIG. 2 is a graph of C-FDMA sub-channel allocation;

FIG. 3 is a flow chart of a method for C-FDMA; and

FIG. 4 is a block diagram of a computing device.

### DETAILED DESCRIPTION

### Overview

Coordinated Frequency Division Multiple Access (C-FDMA) may be provided. C-FDMA may include determining sub-channels of a channel for each of a plurality of Access Points (APs). The sub-channels may then be assigned to the plurality of APs. Transmit Opportunities (TxOps) may be scheduled for the plurality of APs on the sub-channels.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Frequency coordination in WiFi-7 and WiFi-8 Multi-Access Point Coordination (MAPC) defines Coordinated Orthogonal Frequency Division Multiple Access (C-OFDMA) for AP coordination to enable simultaneous transmission without interference. Because of the need to maintain the orthogonality of Resource Units (RUs) or tones transmitted by adjacent Access Points (APs) to avoid interference when using C-OFDMA, the transmitters of the adjacent APs may have to be synchronized in both frequency and phase. Ideally, APs may be synchronized to a degree based on the sub-symbol or guard-interval (e.g., every 400 nanoseconds) to ensure the transmissions of APs do not cause interference. For some standard wireless network coordination examples, maintaining the orthogonality of the RUs when using C-OFDMA may be possible to implement because a leader AP may transmit a Trigger-Frame (TF) to all the followers that can be used to establish synchronization. However, other approaches where coordination may be performed over the wired network due to relatively large time-sync errors in that domain may not be able to utilize C-OFDMA without interference. To address the limitations of C-OFDMA, Coordinated Frequency Division Multiple Access (C-FDMA) is described herein.

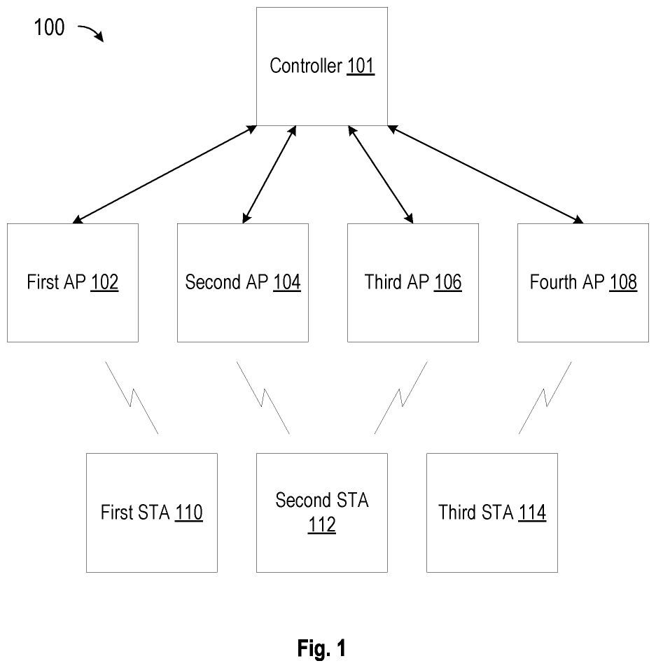

FIG. 1 is a block diagram of an operating environment 100 for (C-FDMA. The operating environment 100 may include a controller 101, a first AP 102, a second AP 104, a third AP 106, a fourth AP 108, a first Station (STA) 110, a second STA 112, and a third STA 114. The controller 101 may be any network controller (e.g., a MAPC controller, a Wireless Local Area Network (WLAN) controller, etc.) operable to control the operations of the network and the devices of the network. The controller 101 may control the operation of network devices, such as coordinating APs for MAPC (e.g., implementing C-FDMA).

The first AP 102, the second AP 104, the third AP 106, and the fourth AP 108 may enable devices, such as the first STA 110, the second STA 112, and the third STA 114, to connect to a network. The first STA 110, the second STA 112, and the third STA 114 may be devices that may connect to a network to communicate with devices, transmit and review data, and the like (e.g., a smartphone, a personal computer, a tablet, a laptop, a server, etc.). The operating environment 100 may have a different number of APs and/or STAs in other examples.

A network may utilize C-FDMA by coordinating or otherwise assigning entire non-orthogonal sub-channels (e.g., in the frequency domain) instead of RUs or tones as C-OFDMA requires. For example, the controller 101 and/or some other network device (e.g., the first AP 102, the second AP 104, the third AP 106, or the fourth AP 108 acting as a controlling AP) may determine the coordination and assignment of sub-channels to perform C-FDMA. The sub-channels may have a channel width of twenty Megahertz (MHZ), forty MHz, and/or the like. The sub-channels may have gaps between them to avoid interference. The controller 101 may determine the sub-channel positions and widths, and therefore the gaps, to ensure sub-channels are separated sufficiently to avoid Adjacent Channel Interference (ACI) that may disrupt the operation of the network.

By coordinating non-orthogonal sub-channels with C-FDMA as opposed to coordinating RUs or sets of orthogonal tones as C-OFDMA requires, the network may have simpler sub-channel granularity and effective frequency division (e.g., no collisions) without the prohibitive symbol-level, time-aligned requirements (e.g., orthogonality guarantee via sub-microsecond time synchronization between APs) of C-OFDMA. C-FDMA may enable the network to use simultaneous Transmit Opportunities (TxOps) across the first AP 102, the second AP 104, the third AP 106, and the fourth AP 108 (e.g., between the first STA 110, the second STA 112, and/or the third STA 114) without causing appreciable Co-Channel Interference (CCI) on the first AP 102, the second AP 104, the third AP 106, the fourth AP 108, the first STA 110, the second STA 112, or the third STA 114. Because C-FDMA may alleviate time synchronization requirements to avoid interference, C-FDMA may be used for wired networks.

C-FDMA may be utilized effectively in environments with channels that have a width that enable allocation of distinct sections of the channel (e.g. the bottom 80 MHz and the top 80 MHz in a 320 Mhz channel) to the first AP 102, the second AP 104, the third AP 106, and the fourth AP 108. For example, the controller 101 may determine sub-channels, including the positions and widths, to create Transmit (Tx) and Receive (Rx) separation. For example, channels described by Wi-Fi 8 would enable C-FDMA.

To determine the which sub-channels the first AP 102, the second AP 104, the third AP 106, and the fourth AP 108 should be assigned, the controller 101 and/or some other network device may estimate the CCI impact on the first AP 102, the second AP 104, the third AP 106, and the fourth AP 108 and on the first STA 110, the second STA 112, and the third STA 114 may have for a sub-channel assignment. The controller 101 may determine the CCI impact on the first AP 102, the second AP 104, the third AP 106, and the fourth AP 108 using AP-to-AP Received Signal Strength Indicator (RSSI) reports (e.g., using the Neighbor Discover Protocol (NDP)) and/or the like. The controller 101 may determine the CCI impact on the first STA 110, the second STA 112, and the third STA 114 using downlink Signal to Interference Ratio (SIR) at the respective STA estimated from beacon reports, using Physical Layer Protocol Data Unit (PPDU) RSSI reports from neighboring APs, and/or the like. The controller 101 may assign the first AP 102, the second AP 104, the third AP 106, and the fourth AP 108 sub-channels based on the estimated CCI impacts on the first AP 102, the second AP 104, the third AP 106, the fourth AP 108, the first STA 110, the second STA 112, and/or the third STA 114 so interference is minimized or otherwise at acceptable levels. For example, the controller 101 may determine that CCI and/or another interference estimation is below a threshold for a set of sub-channels before assigning the sub-channels to the APs.

In other embodiments, the controller 101 may determine which sub-channels the first AP 102, the second AP 104, the third AP 106, and the fourth AP 108 should use based on spectral efficiency. The controller 101 may evaluate the spectral efficiency realized by different sub-channel assignments using AP-to-STA distances, rogue channel configurations, AP types, and/or the like. For example, the controller 101 may evaluate spectral efficiency using Dynamic Bandwidth Selection (DBS) feedback. The DBS feedback may be STA-initiated, per sub-channel, in real time, and/or the like. The controller 101 may then allocate sub-channels to the first AP 102, the second AP 104, the third AP 106, and the fourth AP 108 for maximal or otherwise acceptable spectral efficiency. For example, the controller 101 may determine the spectral efficiency for a set of sub-channels is above a threshold before assigning the sub-channels to the APs.

Once the first AP 102, the second AP 104, the third AP 106, and the fourth AP 108 are assigned sub-channels, the first AP 102, the second AP 104, the third AP 106, and the fourth AP 108 may share a time schedule (e.g., from a Coordinated Time Division Multiple Access (C-TDMA) scheduler, from Stream Classification Service (SCS) flows, etc.) and may not require any other coordination. The first AP 102, the second AP 104, the third AP 106, and the fourth AP 108 may then determine which STA (e.g., the first STA 110, the second STA 112, and/or the third STA 114) to serve in subsequent TxOps using the assigned sub-channels via C-FDMA.

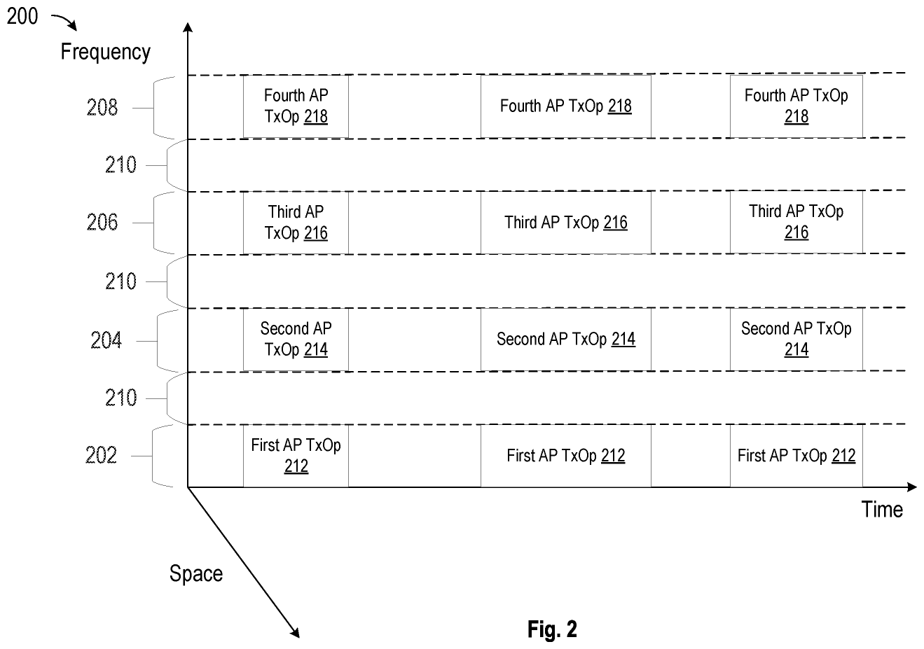

FIG. 2 is a graph 200 of C-FDMA sub-channel allocation. The graph 200 may include a first AP sub-channel 202, a second AP sub-channel 204, a third AP sub-channel 206, a fourth AP sub-channel 208 and gaps 210. The controller 101 may determine the positions and widths of the first AP sub-channel 202, the second AP sub-channel 204, the third AP sub-channel 206, the fourth AP sub-channel 208 and the gaps 210 to avoid interference as described above. The first AP sub-channel 202, the second AP sub-channel 204, the third AP sub-channel 206, and the fourth AP sub-channel 208 may have the same width in the graph 200, but the controller 101 may determine different widths in other examples, for example based on the expected operations of the associated APs. The gaps 210 may have the same width in the graph 200, but the controller 101 may determine different gaps 210 between the sub-channels in additional examples.

The first AP 102 may have one or more first AP TxOps 212 in the first AP sub-channel 202. The first AP 102 may communicate with (e.g., Tx and/or RX) the first STA 110, the second STA 112, and/or the third STA 114 during a first AP TxOp 212. Similarly, the second AP 104 may have one or more second AP TxOps 214 in the second AP sub-channel 204, the third AP 106 may have one or more third AP TxOps 216 in the third AP sub-channel 206, and the fourth AP 108 may have one or more fourth AP TxOps 218 in the fourth AP sub-channel 208. The controller 101 may determine the times the first AP TxOps 212, the second AP TxOps 214, the third AP TxOps 216, and the fourth AP TxOps 218 occur. The controller 101 may align the TxOps to occur at the same time in some examples or may independently schedule the TxOps.

In some examples, the controller 101 may determine Tx sub-channels and Rx subchannels for each AP. Thus, the first AP 102, the second AP 104, the third AP 106, and the fourth AP 108 may each have two sub-channels, one for Tx and one for Rx, instead of the single sub-channel as shown in the graph 200. The controller 101 may position the Tx and Rx channels for sufficient frequency separation to avoid interference.

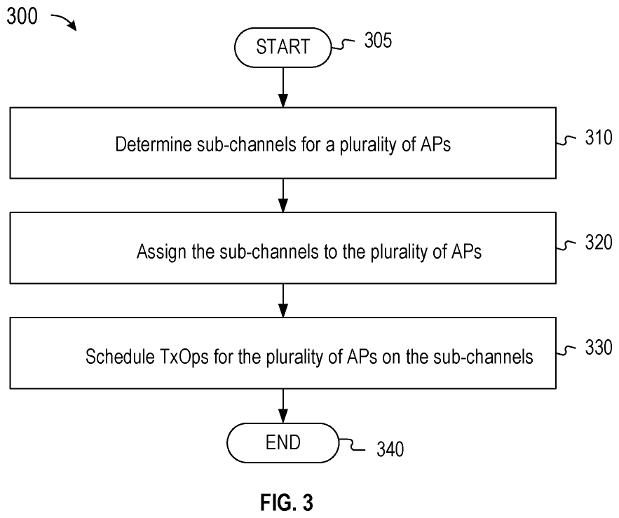

FIG. 3 is a block diagram of a method 300 for C-FDMA. The method 300 may begin as starting block 305 and proceed to operation 310. In operation 310, sub-channels of a channel may be determined for each of a plurality of APs. For example, the controller 101 may determine sub-channels for the first AP 102, the second AP 104, the third AP 106, and the fourth AP 108. The controller 101 may estimate interference (e.g., CCI) and/or spectral efficiency to determine the positions and widths of the sub-channels. The controller 101 may also determine a Tx sub-channel and a Rx sub-channel for each AP in some examples.

In operation 320, the sub-channels may be assigned to the plurality of APs. For example, the controller 101 may inform the first AP 102, the second AP 104, the third AP 106, and the fourth AP 108 the sub-channel(s) each AP is assigned.

In operation 330, TxOps for the plurality of APs may be scheduled on the sub-channels. For example, the controller 101 may schedule TxOps as different times, including simultaneously, for the APs. For example, the controller 101 may schedule the first AP TxOps 212, the second AP TxOps 214, the third AP TxOps 216, and the fourth AP TxOps 218. The method 300 may conclude at ending block 340.

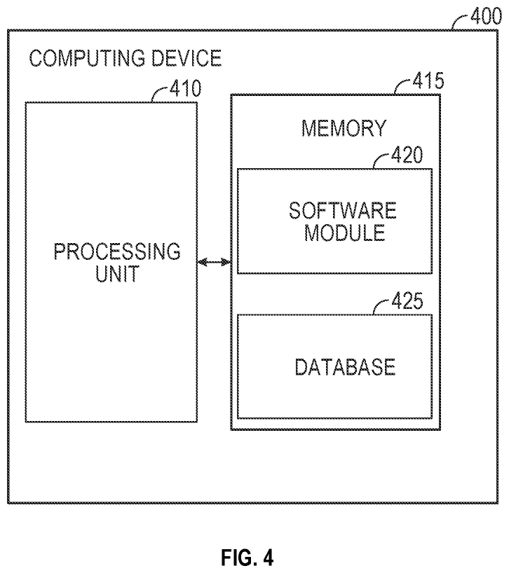

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for C-FDMA with respect to FIG. 1, FIG. 2, and FIG. 3. Computing device 400, for example, may provide an operating environment for the controller 101, the first AP 102, the second AP 104, the third AP 106, the fourth AP 108, the first STA 110, the second STA 112, the third STA 114, and the like. The controller 101, the first AP 102, the second AP 104, the third AP 106, the fourth AP 108, the first STA 110, the second STA 112, the third STA 114, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining sub-channels of a channel for each of a plurality of Access Points (APs);
assigning the sub-channels to the plurality of APs; and
scheduling Transmit Opportunities (TxOps) for the plurality of APs on the sub-channels.

2. The method of claim 1, wherein the sub-channels have any one of a width of: (i) twenty Megahertz (MHZ), (ii) forty MHz, or (iii) a combination of (i) and (ii).

3. The method of claim 1, wherein determining the sub-channels comprises:
estimating Co-Channel Interference (CCI); and
determining the CCI is below a threshold.

4. The method of claim 1, wherein determining the sub-channels comprises determining positions of the sub-channels to create gaps between the sub-channels.

5. The method of claim 1, wherein determining the sub-channels comprises:
estimating a spectral efficiency; and
determining the spectral efficiency is above a threshold.

6. The method of claim 1, wherein determining the sub-channels comprises:
determining positions and widths of the sub-channels so estimated interference is below a threshold.

7. The method of claim 1, wherein scheduling the TxOps comprises scheduling one or more of the TxOps of one or more of the plurality of APs at simultaneous times.

8. A system comprising:
a memory storage; and
a processing unit coupled to the memory storage, wherein the processing unit is operative to:
determine sub-channels of a channel for each of a plurality of Access Points (APs);
assign the sub-channels to the plurality of APs; and
schedule Transmit Opportunities (TxOps) for the plurality of APs on the sub-channels.

9. The system of claim 8, wherein the sub-channels have any one of a width of: (i) twenty Megahertz (MHz), (ii) forty MHz, or (iii) a combination of (i) and (ii).

10. The system of claim 8, wherein to determine the sub-channels comprises to:
estimate Co-Channel Interference (CCI); and
determine the CCI is below a threshold.

11. The system of claim 8, wherein to determine the sub-channels comprises to determine positions of the sub-channels to create gaps between the sub-channels.

12. The system of claim 8, wherein to determine the sub-channels comprises to:
estimate a spectral efficiency; and
determine the spectral efficiency is above a threshold.

13. The system of claim 8, wherein to determine the sub-channels comprises to:
determine positions and widths of the sub-channels so estimated interference is below a threshold.

14. The system of claim 8, wherein to schedule the TxOps comprises to schedule one or more of the TxOps of one or more of the plurality of APs at simultaneous times.

15. A non-transitory computer-readable medium that stores a set of instructions which when executed perform a method executed by the set of instructions comprising:
determining sub-channels of a channel for each of a plurality of Access Points (APs);
assigning the sub-channels to the plurality of APs; and
scheduling Transmit Opportunities (TxOps) for the plurality of APs on the sub-channels.

16. The non-transitory computer-readable medium of claim 15, wherein the sub-channels have any one of a width of: (i) twenty Megahertz (MHZ), (ii) forty MHz, or (iii) a combination of (i) and (ii).

17. The non-transitory computer-readable medium of claim 15, wherein determining the sub-channels comprises:
estimating Co-Channel Interference (CCI); and
determining the CCI is below a threshold.

18. The non-transitory computer-readable medium of claim 15, wherein determining the sub-channels comprises determining positions of the sub-channels to create gaps between the sub-channels.

19. The non-transitory computer-readable medium of claim 15, wherein determining the sub-channels comprises:
estimating a spectral efficiency; and
determining the spectral efficiency is above a threshold.

20. The non-transitory computer-readable medium of claim 15, wherein scheduling TxOps comprises scheduling one or more of the TxOps of one or more of the plurality of APs at simultaneous times.
